(19) United States
(12) Patent Application Publication
(10) Pub. No.: US 2018/0159246 A1
(43) Pub. Date: Jun. 7, 2018

(54) MODULAR ARCHITECTURE OF THE MIMO RADAR

(71) Applicant: GM GLOBAL TECHNOLOGY OPERATIONS LLC, Detroit, MI (US)

(72) Inventors: Dani Raphaeli, Kfar Saba (IL); Igal Bilik, Rehovot (IL); Oded Bialer, Petah Tivak (IL)

(21) Appl. No.: 15/369,366

(22) Filed: Dec. 5, 2016

(51) Int. Cl. H01Q 21/06; H01Q 1/38

(52) U.S. Cl. CPC H01Q 21/061; H01Q 1/38

(57) ABSTRACT

A multiple input multiple output (MIMO) antenna for a radar system, the antenna for at least one first module having a plurality of antenna elements forming a linear array, wherein the plurality of antenna elements in the linear array are uniformly separated by a first distance; and for at least one second module having a plurality of antenna elements forming a planar array, wherein the plurality of antenna elements in the planar array are uniformly separated by a second distance; and wherein the at least one first module and the at least one second module are selectively configured to function as transmitter modules or receiver modules, and wherein an interleaving between the plurality of antenna elements in the linear array of the at least one first module with the plurality of antenna elements in the planar array of the at least one second module produces a uniform virtual antenna array.

### TECHNICAL FIELD

The present invention relates generally to multiple-input multiple-output (MIMO) antenna arrays, and more particularly, to a modular and configurable MIMO antenna array architecture.

### BACKGROUND

Advanced radar systems in use today use a multiple-input multiple-output (MIMO) concept that employs multiple antennas at the transmitter to transmit independent (orthogonal) waveforms and multiple antennas at the receiver to receive the radar echoes. In a “collocated” MIMO radar configuration, the antennas in both the transmitter and the receiver are spaced sufficiently close so that each antenna views the same aspect of an object such that a point target is assumed. In the MIMO receiver, a matched filter bank is used to extract the orthogonal waveform components. When the orthogonal signals are transmitted from different antennas, the echoes of each signal carry independent information about detected objects and the different propagation paths. Phase differences caused by different transmitting antennas along with phase differences caused by different receiving antennas mathematically form a virtual antenna array that provides for a larger virtual aperture using fewer antenna elements. Conceptually, the virtual array is created by an interleaving between each of the transmitter Tₓ and receiver Rₓ antenna elements such that the elements in the virtual array represent Tₓ-Rₓ pairs for each of the transmitter Tₓ and receiver Rₓ antennas in the MIMO array. For collocated MIMO antennas, a transmit array having N_{Tx} transmitter antennas and a receive array having N_{Rx} receiver antennas produces a virtual array having N_{Tx}N_{Rx} virtual receiver elements. In other words, the orthogonal waveforms are be extracted by the matched filters at the receiver such that there are a total of N_{Tx}N_{Rx} extracted signals in the virtual array.

As understood by those skilled in the art, the interleaving between the transmitter Tₓ and receiver Rₓ antenna elements in uniformly spaced linear arrays requires a non-half-wavelength interelement spacing between either the transmit or receive array elements in order to maintain a uniform virtual array. For example, as illustrated by the known MIMO array 10 configuration in FIG. 1, if the spacing d_{R} between receiver Rₓ antenna elements in the receive array 12 is a half-wavelength, the spacing d_{T} between the transmitter Tₓ antenna elements in the transmit array 14 must be N_{Rx}d_{R} to maintain uniform spacing in the virtual array 16, where N_{Rx} is the number of receiver antennas. The inverse spatial relationship (not shown) also applies, wherein if the spacing d_{T} between the transmitter Tₓ antenna elements in the transmit array is a half-wavelength, to maintain a uniform virtual array, the spacing d_{R} between receiver Rₓ antenna elements in the receive array must be N_{Tx}d_{T}, wherein Nₜₓ is the number of transmitter Tₓ antenna elements.

Traditionally, MIMO antenna arrays as shown in FIG. 1 are fabricated on a signal board and are designed such that the array hardware (i.e., antenna elements and associated electronic devices) is oriented in a fixed arrangement and its function limited to the specific application requirements for which it was designed.

### SUMMARY

According to an embodiment of the invention, there is provided a multiple input multiple output (MIMO) antenna for a radar system, the antenna for at least one first module having a plurality of antenna elements forming a linear array, wherein the plurality of antenna elements in the linear array are uniformly separated by a first distance; and for at least one second module having a plurality of antenna elements forming a planar array, wherein the plurality of antenna elements in the planar array are uniformly separated by a second distance; and wherein the at least one first module and the at least one second module are selectively configured to function as transmitter modules or receiver modules, and wherein an interleaving between the plurality of antenna elements in the linear array of the at least one first module with the plurality of antenna elements in the planar array of the at least one second module produces a uniform virtual antenna array.

According to another embodiment of the invention, there is provided a multiple input multiple output (MIMO) antenna for a radar system, the antenna for a modular antenna array assembly having a plurality of antenna boards, each of the plurality of antenna boards having an array portion and a circuit portion; and wherein the array portion of at least one of the plurality of antenna boards includes a first plurality of antenna elements forming a linear array, and wherein the array portion of at least another one of the plurality of antenna boards includes a second plurality of antenna elements forming a planar array; and wherein the circuit portion of each of the plurality of antenna boards includes one or more electronic devices configured to control the array portions of the plurality of antenna boards to function as a transmitter antenna array or as a receiver antenna array, and wherein the modular antenna array assembly has at least one of the plurality of antenna boards configured as a transmitter antenna array and at least one of the plurality of antenna boards configured as a receiver antenna array.

According to another embodiment of the invention, there is provided a multiple input multiple output (MIMO) antenna for a radar system, the antenna for a modular antenna array assembly having one or more linear antenna array boards each having a plurality of antenna elements forming a uniform linear array, and one or more planar antenna array boards each having a plurality of antenna elements forming a uniform planar array, wherein each of the one or more linear antenna array boards and each of the one or more planar antenna array boards includes circuitry configured to operate the linear arrays of the one or more linear antenna array boards and the planar arrays of the one or more planar antenna array boards as either transmitter arrays or receiver arrays; wherein the modular antenna array assembly has an equal number of linear antenna array boards and planar antenna array boards, and when the circuitry of the one or more linear antenna array boards operates as one of a transmitter array or a receiver array, then the circuitry of the one or more planar antenna array boards operates as the other.

### BRIEF DESCRIPTION OF THE DRAWINGS

One or more embodiments of the invention will hereinafter be described in conjunction with the appended drawings, wherein like designations denote like elements, and wherein:

FIG. 1 illustrates a known configuration for a MIMO antenna array; and

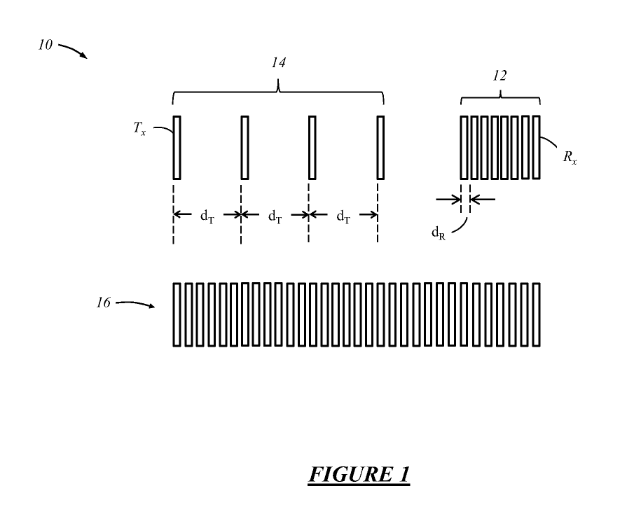

FIG. 2 illustrates an exemplary architecture of MIMO antenna array according to an embodiment of the present invention; and

FIG. 3 illustrates a virtual array formed by the MIMO antenna array of FIG. 2.

### DETAILED DESCRIPTION OF THE ILLUSTRATED EMBODIMENT(S)

The system and method described below are directed to a modular and configurable MIMO antenna array architecture. In one embodiment, the modular array includes a plurality of antenna modules, each having a plurality of antenna elements arranged to form either a linear or a planar array. Each antenna module further includes transmitter or receiver circuitry such that the linear and planar arrays on each board can be configured to operate as either a transmitter array or a receiver array. The interelement spacing between the antenna elements in both the linear and planar arrays are chosen such that the MIMO antenna array formed by a select combination of the linear and planar arrays form a uniformly spaced virtual array.

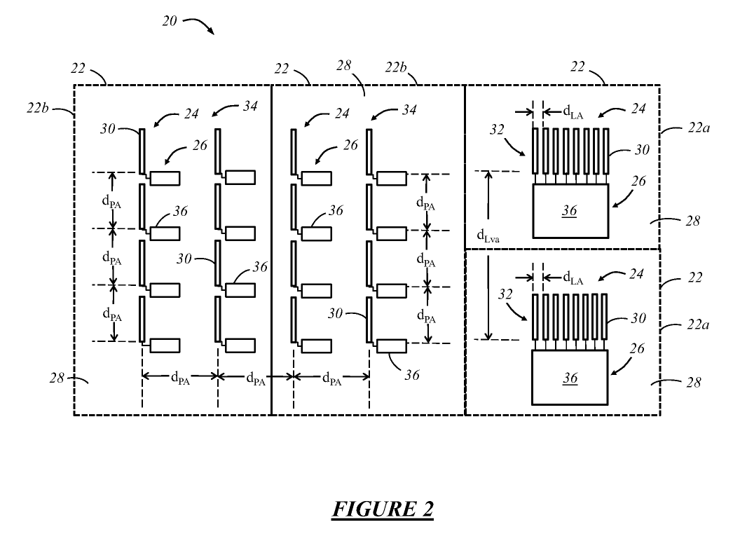

FIG. 2 illustrates an exemplary architecture for a MIMO antenna array 20 according to at least one embodiment of the present invention. The antenna array 20 is modular structure formed by a plurality of antenna modules 22 each having an array portion 24 and a circuit portion 26 arranged on a surface 28 having reference axes in the horizontal (azimuth) and vertical (elevation) directions. In one embodiment, the surface 28 is a printed circuit board that mechanically supports and electrically connects electronic components of the antenna array 20 using conductive tracks, pads, and other features etched from copper sheets laminated onto a non-conductive substrate. The printed circuit boards can be single sided, double sided, or multi-layer. Conductors on different layers may be connected with plated-through holes called vias. The electronic components may be printed onto the printed circuit board and/or may contain components embedded in the substrate. Therefore, in one embodiment, the antenna modules 22 may also be referred to as antenna boards. The arrangement of the array portion 24 and the circuit portion 26 in each of the antenna modules 22 is designed to be compact and maximizes the utilization of the available surface area on the printed circuit board.

The array portion 24 of each antenna module 22 includes a plurality of antenna elements 30 arranged to form either a linear array 32 or a planar array 34. As such, each of the antenna modules 22 in antenna array 20 is configured as either a linear array module 22a or a planar array module 22b. As understood by those skilled in the art, the shape of the antenna element 30 influences the antenna response. Consistent with automotive applications, the antenna elements in the illustrated embodiment are narrow in the horizontal axis and long in the vertical axis, which generates a narrow radiation angle in the vertical axis and a wide angle in the horizontal axis. However, the shape of the antenna elements in the illustrated embodiment is merely exemplary and non-limiting. One of ordinary skill in the art appreciates that the array configuration disclosed herein for each of the antenna modules 22 may be applicable to any suitably shaped antenna element.

The antenna elements 30 in the linear array modules 22a are separated by a distance d_{LA}, which in one embodiment is uniform and equal to 0.5λ, to maintain a uniform and unambiguous beam pattern in the azimuth domain. Referring to planar array module 22b, the planar array 34 has a plurality of columns and rows having a total of M_{PA}×N_{PA} antenna elements 30, where M_{PA} is the number of antenna elements in each column and N_{PA} is the number of antenna elements in each row. In one embodiment, the adjacent antennas elements 30 in any given row or column of planar array 30 are equidistant with interelement spacing d_{PA}. In an antenna array having at least one linear array module 22a and at least one planar array module 22b, the interelement spacing d_{PA} is proportional to the aperture of the linear array 32 in order to maintain uniform spacing in the virtual array. In one embodiment, the interelement spacing d_{PA}=d_{LA}N_{LA}, where d_{LA} is the distance between the antenna elements 30 in the linear array modules 22a and N_{LA} is the number of antenna elements 30 in the linear array module 22a. While the spacing d_{PA} between phase centers of the antennas elements 30 in the planar array 34 is the same in the horizontal and vertical axes, due to the geometry of the antenna elements, the physical appearance of the spacing between the antenna elements 30 in the horizontal and vertical axes appears different. In other words, the physical distance between the antenna elements 30 in each row along the horizontal axis appears wider relative to the physical spacing between the antenna elements 30 in each column along the vertical axis.

The circuit portion 26 of each of the antenna modules 22 includes one or more electronic devices 36 associated with the plurality of antenna elements 30. The electronic devices 36 may include without limitation, components and/or devices that comprise transmitter and receiver circuitry such as, for example, power dividers, amplifiers, converters, filters, etc. as known in the art. In the embodiment shown in FIG. 2, the electronic devices 36 are integrated circuits or chips arranged on the surface 28 of the printed circuit board located proximate to each of the elements 30. The electronic devices 36 are configured to control the antenna elements 30 in the array portion 24 of the antenna modules 22 to operate as either transmitter or receiver antennas. In this way, the linear arrays 32 in the linear array modules 22a and the planar arrays 34 in the planar array modules 22b can be implemented as either transmitter arrays or receiver arrays using the same hardware antenna element components. In one embodiment, the electronic devices 36 are removable (e.g., electronic chips) such that the array modules 22a, 22b can be configured to operate as either transmit or a receive arrays by replacing the electronic devices 36.

In the exemplary embodiment shown in FIG. 2, antenna array 20 is formed by a combination of four antenna modules 22, two of which are linear array modules 22a and two of which are planar array modules 22b. The linear array modules 22a are arranged adjacently such that the linear arrays 32 are parallel along the horizontal axis. The planar array modules 22b are also arranged adjacently such that the planar arrays form a combined planar array. In the non-limiting example shown in FIG. 2, the number N_{LA} of antenna elements 24 in each linear array module 22a is equal to 8, and the number N_{PA} of antenna elements 24 in each planar array modules 22b is equal to 8. The resulting modular antenna array 20 is then a 32-element antenna array 20 having a planar array with 16 antenna elements, and two parallel linear arrays with a total of 16 antenna elements. As understood by one of ordinary skill in the art, the number of antenna elements 24 in each of the antenna modules 22 may vary depending on the desired size of the overall antenna array, the size of the mounting surface, and/or MIMO antenna array performance metrics. However, each linear array module 22a is the same and each planar array module 22b is the same, such that each linear array module 22a has the same number and configuration of antenna elements, and each planar array module 22b has the same number and configuration of antenna elements.

Moreover, in general, the linear array modules 22a function together and the planar array modules 22b function together such that all of the linear array modules 22a in an antenna array 20 are configured to operate in the same transmitter or receiver manner (i.e., as one of either a transmitter or receiver array), and all of the planar array modules 22b in the antenna array 20 are configured to operate in the same transmitter or receiver manner. In other words, the linear arrays 32 for a particular array all function as either receiver arrays or transmitter arrays, but not both in a given antenna array 20. The same applies for the planar arrays 34 in that all function as receiver arrays or transmitter arrays, but not both. In addition, the linear arrays 32 and the planar arrays 34 have distinct and opposite functionality in that if the linear arrays 32 are configured to operate as receiver arrays, then the planar arrays 34 are configured to operate as transmitter arrays, and vice versa. For example, in one particular implementation, if the linear array modules 22a shown in FIG. 2 are configured as receiver modules such that the linear arrays 32 function as receiver arrays, then the planar array modules 22b would be configured as transmitter modules such that the planar arrays 34 would function as transmitter arrays.

The linear array modules 22a and the planar array modules 22b, both as individual modules relative to one another, and as a combined modular antenna array 20 as shown in FIG. 2, are selectively oriented such that the MIMO operation is mixed between the azimuth and elevation domains. In other words, the linear array modules 22a and the planar array modules 22b are arranged such that the density of the interelement spacing in each of the respective arrays 32, 34 is mixed with respect to both the horizontal and vertical apertures of the antenna array 20. For example, from the perspective of the horizontal aperture of the antenna array 20, the interelement spacing between the antenna elements 30 in the planar array(s) 34 is relatively sparse (i.e., widely-spaced) compared to the relatively dense interelement spacing between the antenna elements 30 in the linear array(s) 32. Conversely, from the perspective of the vertical aperture of the antenna array 20, the effective spacing between the antenna elements 30 in the planar array(s) 34 is relatively dense compared to the relatively sparse spacing between the linear receiver array(s) 32.

As understood by those skilled in the art, to form a virtual array having uniform spacing, the interelement spacing between like elements 30 in adjacent modules (i.e., between adjacent linear array modules 22a and between adjacent planar array modules 22b) must also be spaced according to the convention set forth above. More specifically, to maintain a uniform virtual array, the spacing between antennas elements 30 in the rows and columns between adjacent planar array modules 22b must also be equidistant and equal to the interelement spacing d_{PA} as shown in FIG. 2, wherein d_{PA}=d_{LA}N_{LA}, where d_{LA} is the distance between the antenna elements 30 in the linear array modules 22a and N_{LA} is the number of antenna elements 30 in the linear array module 22a. In addition, when two or more linear arrays modules 22a are combined as shown in FIG. 2, the linear arrays 32 are separated by distance d_{Lva} in the vertical axis. The distance d_{Lva} between the linear arrays 32 is proportional to the size and configuration of the overall planar array created by the combination of one or more planar array modules 22b. In one embodiment, d_{Lva}=Mₜ d_{PA}, where Mₜ is the number of antenna elements 30 in each column of the planar arrays 34.

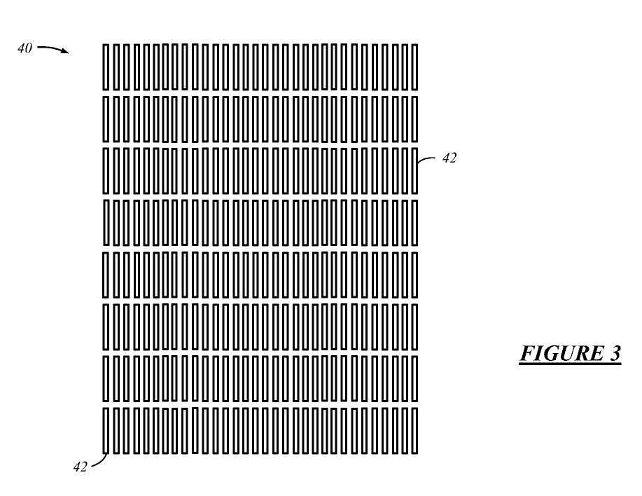

As shown in FIG. 3b, the resulting virtual array 40 formed by antenna array 20 produces a large virtual aperture providing a high angular resolution in both the azimuth and elevation dimensions and has uniform spacing in the horizontal axis and vertical axis. Using the principles of operation with respect to MIMO, the virtual array 40 formed by antenna array 20 is a 256 element (N_{PA}N_{LA}) receiver array having 32 uniformly spaced elements 42 in the azimuth and 8 uniformly spaced elements 42 in the elevation. As understood by those skilled in the art, due to the operation of a MIMO antenna array, the number of virtual receiver antennas in the horizontal aperture of the virtual array formed by a collocated MIMO antenna array is equal to N_{PH}N_{LH}, where N_{PH} is the number of antenna elements 30 in the planar array 34 that are positioned along the horizontal axis of the antenna array 20, and N_{LH} is the number of antenna elements 30 in the linear array 32 positioned along the horizontal axis of the antenna array 20. Similarly, the number of virtual receiver antennas in the vertical aperture is equal to N_{PV}N_{Lv}, where N_{PV} is the number of antenna elements 30 in the planar array 34 positioned along the vertical axis of the antenna array 20 and N_{LV} is the number of antenna elements 30 in the linear array 32 positioned along the vertical axis of the antenna array 20. Moreover, it is known that the MIMO virtual array positions are a convolution of traditional transmit and receive array element positions.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A multiple input multiple output (MIMO) antenna for a radar system, the antenna comprising:
at least one first module having a plurality of antenna elements forming a linear array, wherein the plurality of antenna elements in the linear array are uniformly separated by a first distance; and
at least one second module having a plurality of antenna elements forming a planar array, wherein the plurality of antenna elements in the planar array are uniformly separated by a second distance;
wherein the at least one first module and the at least one second module are selectively configured to function as transmitter modules or receiver modules, and wherein an interleaving between the plurality of antenna elements in the linear array of the at least one first module with the plurality of antenna elements in the planar array of the at least one second module produces a uniform virtual antenna array.

2. The MIMO antenna of claim 1, wherein the at least one first module and the at least one second module further include one or more electronic devices associated with, and located proximate to, the plurality of antenna elements in each of the first and second modules, and wherein the function of the at least one first module and the at least one second module as a transmitter module or receiver module is determined based on the one or more electronic devices.

3. The MIMO antenna of claim 1, wherein the at least one first module and the at least one second module are fabricated on individual printed circuit boards.

4. The MIMO antenna of claim 1, wherein the at least one first module is a plurality of first modules and the at least one second module is a plurality of second modules, wherein the plurality of first modules are arranged adjacently to form parallel linear arrays, and wherein the plurality of second modules are arranged adjacently to form a combined planar array.

5. The MIMO antenna of claim 4, wherein each of the plurality of first modules are the same, and each of the plurality of second modules are the same.

6. The MIMO antenna of claim 1, wherein along a first axis, an interelement spacing between the plurality of antennas in the at least one first module is dense relative to an interelement spacing between the plurality of antennas in the at least one second module; and along a second axis, the interelement spacing between the plurality of antennas in the at least one second module is dense relative to the interelement spacing between the plurality of antennas in the at least one first module.

7. The MIMO antenna of claim 1, wherein the second distance between the plurality of antennas in the at least one second module is equal to the first distance between the plurality of antennas in at least one first module times a number of antennas in the linear array.

8. The MIMO antenna of claim 1, wherein the first distance between the plurality of antennas in the at least one first module is equal to 0.5λ, where λ is a wavelength of a transmit signal of the antenna.

9. The MIMO antenna of claim 1, wherein the second distance between the plurality of antennas in the at least one second module is equal to 0.5λ times a number of the plurality of antenna elements in the linear array of the at least one first module, where λ is a wavelength of a transmit signal of the antenna.

10. The MIMO antenna of claim 1, wherein a number of the plurality of antenna elements in the linear array of the at least one first module is equal to a number of the plurality of antenna elements in the planar array of the at least one second module.

11. A multiple input multiple output (MIMO) antenna for a radar system, the antenna comprising:
a modular antenna array assembly having a plurality of antenna boards, each of the plurality of antenna boards having an array portion and a circuit portion;
wherein the array portion of at least one of the plurality of antenna boards includes a first plurality of antenna elements forming a linear array, and wherein the array portion of at least another one of the plurality of antenna boards includes a second plurality of antenna elements forming a planar array;
wherein the circuit portion of each of the plurality of antenna boards includes one or more electronic devices configured to control the array portions of the plurality of antenna boards to function as a transmitter antenna array or as a receiver antenna array, and wherein the modular antenna array assembly has at least one of the plurality of antenna boards configured as a transmitter antenna array and at least one of the plurality of antenna boards configured as a receiver antenna array.

12. The MIMO antenna of claim 11, wherein the first plurality of antenna elements forming the linear array are separated by a first distance equal to 0.5λ, where λ is a wavelength of a transmit signal of the modular antenna array.

13. The MIMO antenna of claim 11, wherein the second plurality of antenna elements forming a planar array are separated by a second distance equal to 0.5λ times a number of the first plurality of antenna elements forming the linear array, where λ, is a wavelength of a transmit signal of the modular antenna array.

14. The MIMO antenna of claim 11, wherein each of the plurality of antenna boards in the modular antenna array assembly is fabricated on an individual printed circuit board.

15. The MIMO antenna of claim 11, wherein the modular antenna array assembly has at least four antenna boards, wherein at least two of the antenna boards have array portions forming linear arrays and at least two of the other antenna boards have array portions forming planar arrays.

16. The MIMO antenna of claim 15, wherein the at least two antenna boards having linear arrays are arranged adjacently to form parallel linear arrays, and wherein the at least two antenna boards having planar arrays are arranged adjacently to form a combined planar array.

17. The MIMO antenna of claim 16, wherein the at least two antenna boards having linear arrays are configured to function as receiver antenna arrays, and the at least two antenna boards having planar arrays are configured to function as transmitter antenna arrays.

18. The MIMO antenna of claim 16, wherein the at least two antenna boards having linear arrays are configured to function as transmitter antenna arrays, and the at least two antenna boards having planar arrays are configured to function as receiver antenna arrays.

19. A multiple input multiple output (MIMO) antenna for a radar system, the antenna comprising:
a modular antenna array assembly having one or more linear antenna array boards each having a plurality of antenna elements forming a uniform linear array, and one or more planar antenna array boards each having a plurality of antenna elements forming a uniform planar array, wherein each of the one or more linear antenna array boards and each of the one or more planar antenna array boards includes circuitry configured to operate the linear arrays of the one or more linear antenna array boards and the planar arrays of the one or more planar antenna array boards as either transmitter arrays or receiver arrays;
wherein the modular antenna array assembly has an equal number of linear antenna array boards and planar antenna array boards, and when the circuitry of the one or more linear antenna array boards operates as one of a transmitter array or a receiver array, then the circuitry of the one or more planar antenna array boards operates as the other.

20. The MIMO antenna of claim 19, wherein the plurality of antenna elements forming the uniform linear array are separated by a distance equal to 0.5λ, and the plurality of antenna elements forming a uniform planar array are separated by a distance equal to 0.5λ, times a number of the plurality of antenna elements forming the linear array, where λ, is a wavelength of a transmit signal of the modular antenna array.
